(19) United States
(12) Patent Application Publication
(10) Pub. No.: US 2026/0065124 A1
(43) Pub. Date: Mar. 5, 2026

(54) Data Matching Using a Pipeline of Models

(71) Applicant: PayPal, Inc., San Jose, CA (US)

(72) Inventors: Avi Simkin, Haifa (IL); Adva Berta Helman, Nofekh (IL); Matan Marudi, Kiryat Ono (IL)

(21) Appl. No.: 18/816,644

(22) Filed: Aug. 27, 2024

(51) Int. Cl. G06N 3/0985

(52) U.S. Cl. CPC G06N 20/00

(57) ABSTRACT

Techniques are disclosed relating to training a prediction model using a pipeline of machine learning models. A system embeds values of records of at least two different data sources within a multi-dimensional embedding space. The system may calculate similarity scores for respective pairs of clusters within the multi-dimensional embedding space. Based on the similarity scores, the system identifies correlations between values of records from the two different data sources. Based on the identified correlations, the system generates matching features and inputs the matching features into a matching model. Based on output of the matching model for the matching features, the system combines similar records from the at least two different data sources, where the combining produces an enhanced data source. The system may then input the enhanced data source into the prediction model. The disclosed record matching techniques may advantageously provide customized matching for prediction models.

### BACKGROUND

### Technical Field

This disclosure relates generally to improvements in data processing, and, more specifically, to data matching techniques for various disparate data sources.

### Description of the Related Art

In various computing scenarios, particularly in computing systems that process large amounts of data electronically, the process of matching records between different data sources is often crucial for integrating data from various different data sources. The process of matching records from different data sources is often referred to as entity resolution or record linkage. Record linkage enhances the quality of data stored by computing systems by generating a combined data source. For example, record linkage between two different data sources leads to an enhanced data source via the removal of redundant records for a given entity and the combination of different data from different records for a given entity. The combination of data from different data sources may be difficult when the data itself does not include specific identifiers for various types of data it includes. For example, if one data source does not include an identifier specifying that its record stores a last name of a user, then a system attempting to perform a record linkage process may not know to combine this record with a record in a second data source that stores the first name of the same user. After combining different data sources, a computing system may utilize the insights, provided by an external data source that was not present in an internal data source of the computing system, to make decisions.

### BRIEF DESCRIPTION OF THE DRAWINGS

FIG. 1 is a block diagram illustrating an example system configured to generate an enhanced data source, according to some embodiments.

FIG. 2 is a diagram illustrating two different example data sources, according to some embodiments.

FIG. 3 is a diagram illustrating an example enhanced data source, according to some embodiments.

FIG. 4 is a diagram illustrating an example embedded space, according to some embodiments.

FIG. 5 is a block diagram illustrating an example feedback loop, according to some embodiments.

FIG. 6 is a block diagram illustrating an example system configured to perform one or more actions based on a prediction of a classifier trained on enhanced data, according to some embodiments.

FIG. 7 is a block diagram illustrating an example system configured to combine data of an existing company and an acquired company, according to some embodiments.

FIG. 8 is a flow diagram illustrating an example method for training a pipeline of machine learning models to generate and utilize an enhanced data source, according to some embodiments.

FIG. 9 is a flow diagram illustrating an example method for automatically generating a prediction using a pipeline of machine learning models that includes a matching model and a prediction model, according to some embodiments.

### DETAILED DESCRIPTION

Large companies generally handle extensive data (often referred to as “big data”), which can cause acquisitions made by these large companies to become complex. Due to the amount of data stored by these large companies, often in different formats, combining the data of two large companies after one company acquires the other is often a complex and time-consuming process. For example, two different large data sources may include overlapping or similar data. A first data source may have a data record for a given user that includes five different attributes, while a second data source may have a data record for the same user that includes seven different attributes for the given user but in different formats than the data record of the first data source. Data stored by large companies may include user data, traffic data, social media data, weather data, investment data, browsing history data, etc. In other situations, a company may pull data from multiple different sources which store data in different formats, such as a database, an application, a website, etc. For example, while an application and a website may include the same or similar data, this data may be stored in columns having different names for their columns. Further in this example, the application may have a table with an additional column that is not found in a table of the website.

Generally, poor matching or linking between different data sources results in a poor combined dataset, which in turn may cause errors in systems that utilize this data to make decisions. For example, if the poorly linked data is used to train a prediction model, this model would likely produce inaccurate predictions. Traditional matching techniques such as strict matching or fuzzy matching may be used to determine which data matches between two different data sources. Strict matching identifies that two records are a match if they include attribute values that are identical. In contrast, fuzzy matching techniques calculate the distance between two strings of data using a matching algorithm such as a Gerund matching algorithm. In this example, if the distance between the two strings is small or non-existent, then traditional matching techniques identify these two strings as a “match.” Such techniques, however, often do not account for strings that store data for the same entity, but different types of data or in different formats. For example, fuzzy matching may not identify a user name string “Patrick” as matching with an email address string “Patrick.Star@gmail.com” since fuzzy matching is looking for an identical or a close match between the two strings.

Alternatives to fuzzy matching often include a matching model that is trained using rule-based matching that includes a list of rules for determining whether two records from two different data sources match. As one example, a rule used to train a traditional matching model may specify that if the names included in two different records are similar and the physical addresses are the same, then these two records match. This type of rule-based matching is often limited and results in inaccurate matching. In addition to traditional matching algorithms not identifying overlapping data having different formats, traditional matching algorithms are often trained separately from the models that require the matching data for enrichment. Further, traditional matching algorithms often depend on manual mapping of relevant columns and a person that is performing the manual mapping having domain expertise.

In order to automatically match data from different data sources without requiring rule-based or manual matching, the disclosed system implements a pipeline of machine learning models that trains a data matching model and a prediction model in tandem by using enhanced data as it is generated by the matching model to train the prediction model and then adjusting the matching model based on performance of the prediction model. In addition, the disclosed data matching techniques implement data embedding techniques to automatically generate matching features for training the matching model. The embedding techniques remove or reduce the need for manual generation or labeling of matching features to be used for training a matching model. For example, the disclosed system embeds the values of columns from multiple different data sources in a multi-dimensional space to identify overlapping column clusters. Based on these overlapping clusters, the embedding techniques are able to identify similar attributes between multiple different data sources. These matching features are then usable to train a matching model to identify which columns originating in different data sources store similar (or identical) information.

The disclosed techniques may advantageously simplify the onboarding process for new data sources with unfamiliar assets. For example, when a given company acquires another company, the given company needs to combine its data with the data of the other company. This process is time-consuming and error prone, often resulting in data duplicates. In addition to automatically identifying similar records within different data sources, the disclosed techniques capture non-trivial combinations between column values. For example, some column values may not be directly related, but may be related in a more nuanced manner. As one specific example, the business name “PayPal” and the URL “PayPal.com” are not identical but include data for the same business. The combination of assets from two different entities using the disclosed techniques is particularly beneficial when the internal data for one of the entities is missing details for end users, for example.

### Example Computer System

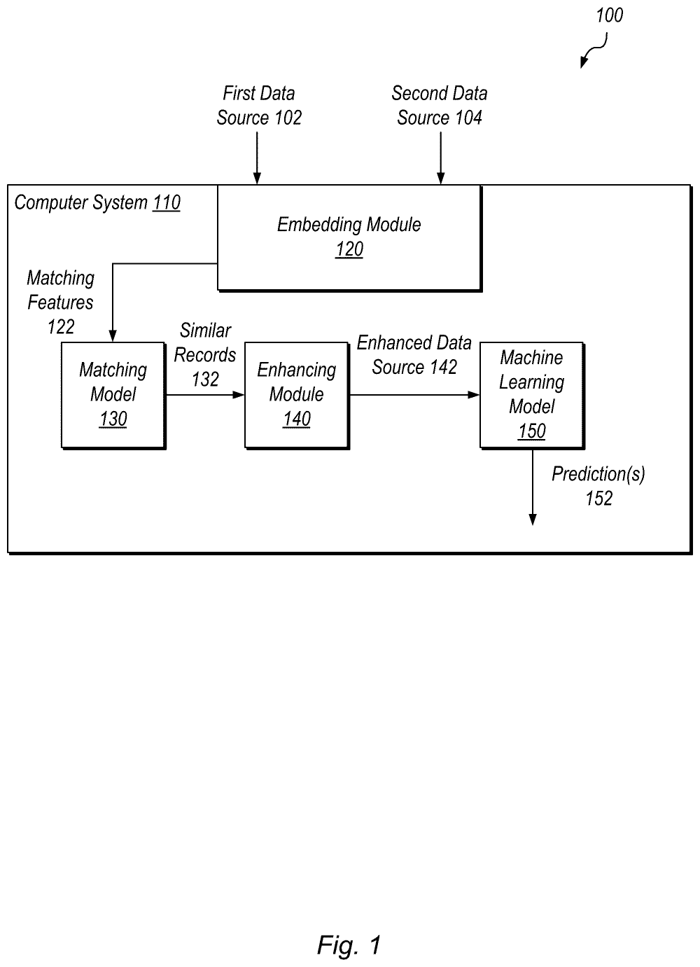

FIG. 1 is a block diagram illustrating an example system configured to generate an enhanced data source. In the illustrated embodiment, a system 100 includes computer system 110, which in turn includes embedding module 120, matching model 130, enhancing module 140, and machine learning model 150.

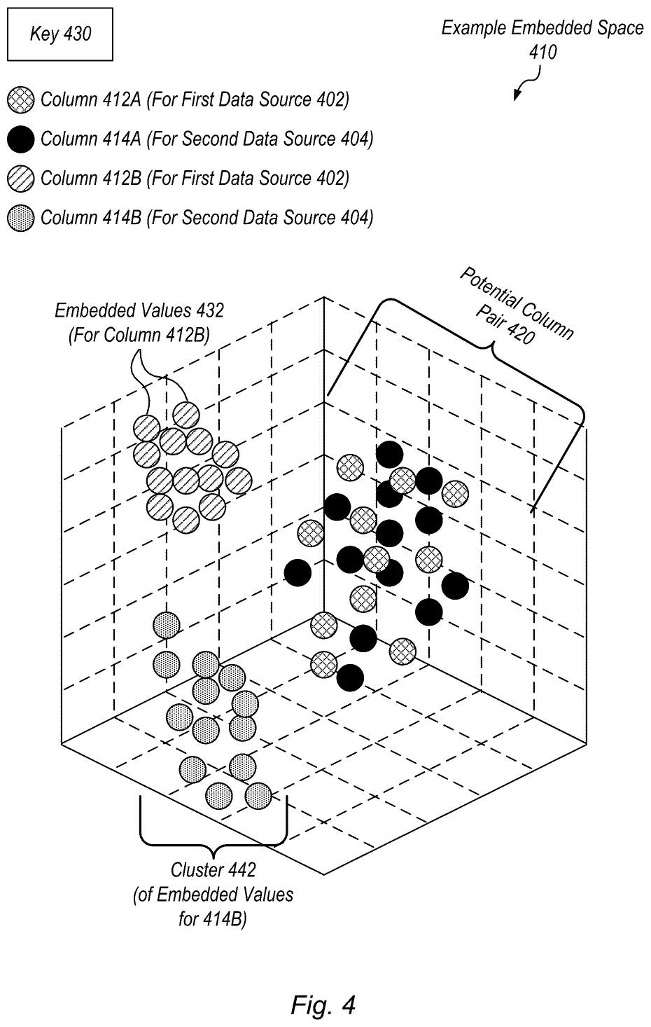

Computer system 110, in the illustrated embodiment, receives first data source 102 and second data source 104 and inputs these two different data sources into embedding module 120. Embedding module 120, in the illustrated embodiment, performs various embedding techniques to generate embedded values within a multi-dimensional embedded space for a plurality of data values included in first data source 102 and second data source 104. Embedding module 120 then calculates similarity scores for the embedded values to determine correlations between data values in first data source 102 and second data source 104. For example, embedding module 120 determines that two or more values in first data source 102 and second data source 104 overlap within a multi-dimensional embedded space. An example multi-dimensional embed space is discussed in detail below with reference to FIG. 4. Based on this determination, embedding module 120, in the illustrated embodiment, generates a set of matching features 122.

Matching model 130, in the illustrated embodiment, receives the set of matching features and identifies one or more records within first data source 102 and one or more records within second data source 104 that are similar. For example, matching model 130 determines that a record from first data source 102 and a record from second data source 104 have one or more matching values. As used herein, the term “matching” refers to two separate sets of data, such as two different records, that include one or more subsets of data for the same entity. For example, if a first data record (a first set of data) includes an attribute value “Bobi” (a subset of the first set of data) and a second data record (a second set of data) includes an attribute value “Bobi Brown” (a subset of the second set of data), then the first and second data records are referred to herein as “matching” records. In various embodiments, matching records are those which store data for the same entity (e.g., an individual, a business, a computer, etc.).

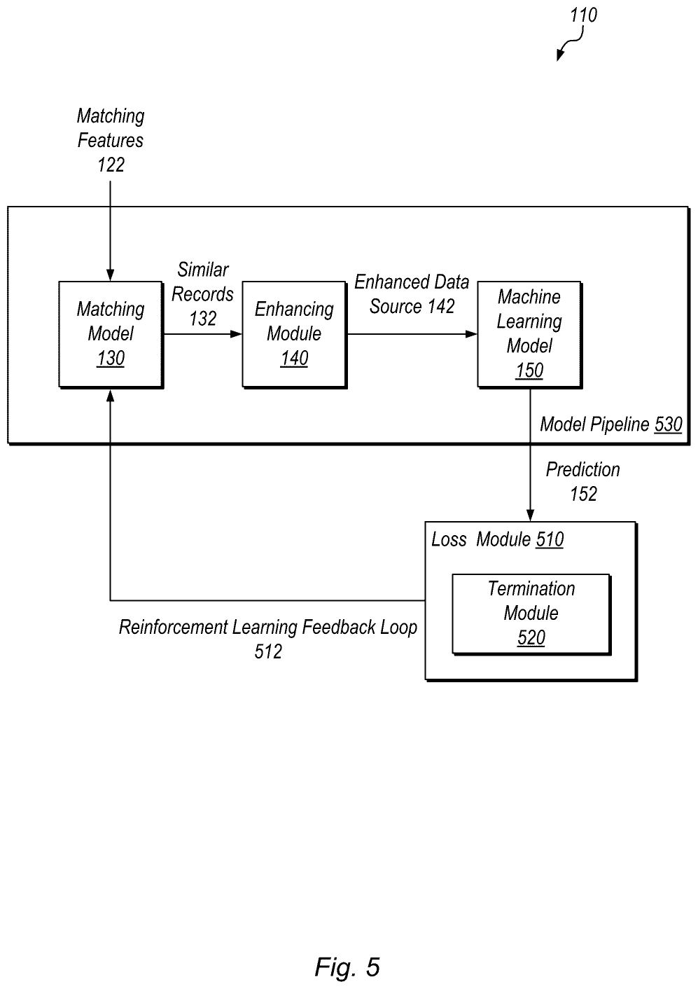

In the illustrated embodiment, matching model 130 receives matching features as input and outputs a prediction indicating whether a record from first data source 102 and a record from second data source 104 store data for the same entity (e.g., the same user). As one specific example, if first data source 102 includes a record for a user named John Doe with an Internet Protocol (IP) address and a physical address of John Doe and second data source 104 includes a record for a user John with the same physical address as John Doe, then matching model 130 outputs information (e.g., a model prediction) indicating that these two records are similar records 132. For example, a prediction output by matching model may be a value between 0 and 1, with values closer to 0 indicating that the two records are not similar and values closer to 1 indicating that the two records are likely a match. In various embodiments, matching model 130 is a neural network trained using backpropagation via a feedback loop as discussed in further detail below with reference to FIG. 5.

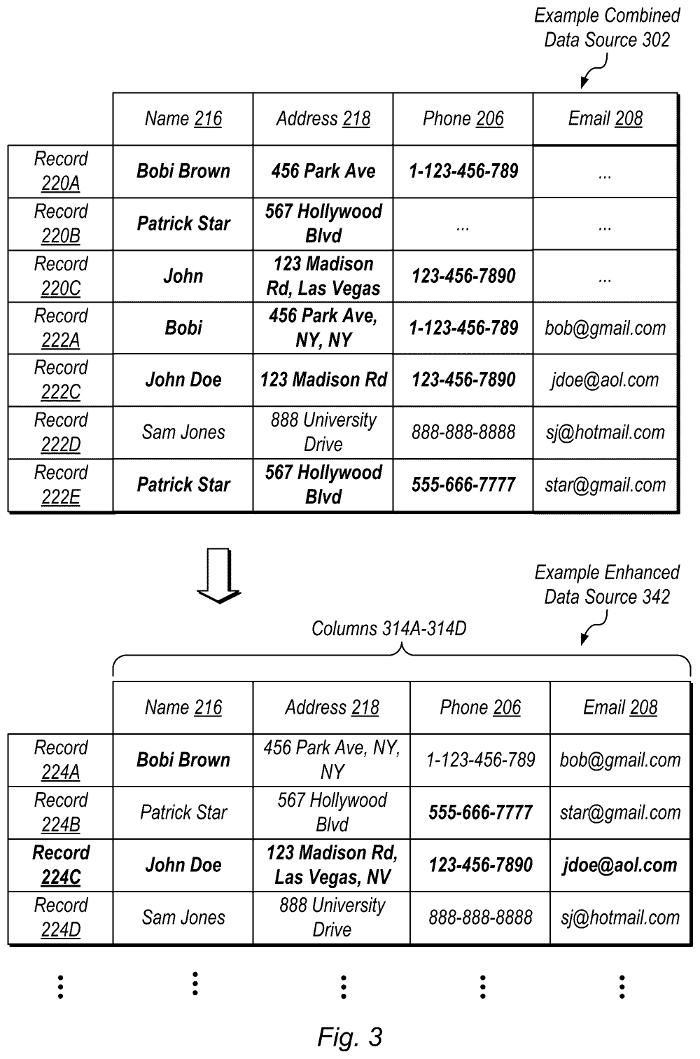

Enhancing module 140, in the illustrated embodiment, receives similar records identified by matching model 130 and combines first data source 102 and second data source 104 to generate an enhanced data source 142. For example, enhancing module 140 places (combines) records from first data source 102 and records from second data source 104 in a single table to generate enhanced data source 142. Further in this example, enhancing module 140 updates the single table by adding together data in a single record from a record of first data source 102 and a record in the second data source 104 that have been identified as similar records 132 by matching model 130. Furthermore, enhancing module 140 generates enhanced data source 142 by removing one or more records that store duplicate data. For example, after taking data from a given record from first data source 102 and adding this data to a matching record in second data source 104, enhancing module 140 deletes the given record from the first data source 102. In this way, enhancing module 140 ensures that enhanced data source 142 does not store two copies of the same data. An example enhanced data source generated by enhancing module 140 is discussed in further detail below with reference to FIG. 3. Enhancing module 140, in the illustrated embodiment, sends enhanced data source 142 to machine learning model 150.

Machine learning model 150, in the illustrated embodiment, receives enhanced data source 142 as input and outputs one or more predictions 152. For example, after enriching its data using matching model 130, computer system 110 generates predictions based on the enriched data for various entities (whose data is included in enhanced data source 142). As one example, when acquiring data from a company, computer system 110 integrates the data from this company with the data that system 100 already owns and maintains. For example, computer system 110 merges its own data source with a data source acquired from the company using the pipeline of models shown in FIG. 1 to automatically identify overlapping accounts of system 100 and the company.

In various embodiments, the automatic match identification process executed by computer system 110 may advantageously decrease the amount of time needed merge two data sources from months or even years down to hours or days. This merged data is then usable by machine learning model 150 to make predictions for system 100. As one example, system 100 is executed by PayPal™. In particular, PayPal executes computer system 110 to match external data (e.g., from a website other than PayPal.com) with PayPal data. In this example, computer system 100, using matching model 130, determines whether data included in the external website matches PayPal data. After determining matches, computer system 110 is able to integrate or place PayPal data within the external website (e.g., without adding duplicate data into the website and while providing data within the website in a cohesive format). As another example, enhanced data produced by matching model 130 and enhancing module 140 is usable by machine learning model 150 to make predictions for one or more of the following: trading and investments (e.g., using enriched data from combining multiple different data sources to predict beneficial stock trading actions), credit approval processes (e.g., should one or more users be approved for a new line of credit based on their enhanced data combined from multiple different sources), marketing (e.g., identify or predict new leads based on new information from data sources external to system 100), user-preference predictions (e.g., providing movie suggestions on a streaming platform based on combining and matching data from social media platforms and the streaming service itself), health predictions (e.g., combining patient data from multiple different doctors' offices, hospitals, etc. to provide a patient diagnosis), etc.

Relative to traditional data matching techniques, the disclosed matching model pipeline provides at least two technical advantages. First, the matching algorithm included in the disclosed system matches data via embedding techniques, rather than strict rule-based matching (which often results in missing matches when matching data has variations in formatting or amount of data). Second, the disclosed training of the matching model and the machine learning model in tandem (i.e., the two models are trained together in a pipeline), may advantageously produce record matching that is customized to the machine learning model itself. As such, the disclosed matching model is not a general matching algorithm, but is customizable to the machine learning model for which it is generating enhanced data. For example, because the output of the machine learning model is used to provide feedback to the matching model, the matching model learns the best way in which to match records that are fed into the machine learning model such that the machine learning model produces accurate predictions. In this way, rather than just having a good matching model, the disclosed matching model is good at matching for the purpose of training the prediction model (e.g., machine learning model 150).

In addition to providing customized record matching via embedding techniques and training via a model pipeline, the disclosed matching model advantageously provides a complexity reduction by dramatically improving processing times relative to traditional matching techniques such as exact matching or fuzzy matching. For example, the disclosed matching techniques provide a computation complexity reduction from a scale of O(2\hat{ }(m1*m2)) to approximately O(2\hat{ }(max(m1, m2))). In these complexity computations, “O” represents the complexity of identifying matching records in terms of timing, “m1” represents the number of columns in a table of a first data source, and “m2” represents the number of columns in a table of the second data source. Traditional matching algorithms are exponentially complex to execute and are, for example, on a scale of 10,000 in terms of complexity (e.g., the amount of computational time and resources it takes to determine matching records between the two tables using traditional matching algorithms). In contrast, the disclosed matching algorithm is executed with a complexity on a scale of 1000 to 2000. The complexity reduction provided by the disclosed matching techniques becomes particularly notable when the tables that are being compared include thousands of different attributes for hundreds or thousands of different records (i.e., systems that store big data). For example, PayPal™ stores data for hundreds of thousands of different entities (e.g., users, businesses, merchants, etc.) with thousands of different attributes for each entity. Thus, in this example, utilizing the disclosed record matching techniques when integrating a new data source with PayPal's existing data source(s) greatly reduces the amount of time and computing resources needed to perform the integration. The complexity reduction provided by the disclosed matching techniques becomes increasingly beneficial when applied in place of manual matching techniques (e.g. the complexity reduction of the disclosed matching techniques relative to manual matching techniques is even greater than the complexity reduction between the disclosed techniques and fuzzy matching techniques). In addition to providing a complexity reduction, the disclosed matching techniques identify pairs of attributes that traditional techniques, such as manual matching or fuzzy matching would not normally identify as matches.

In this disclosure, various “modules” operable to perform designated functions are shown in the figures and described in detail (e.g., embedding module 120, enhancing module 140, loss module 510 (discussed below), and termination module (discussed below), etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

### Example Data Sources

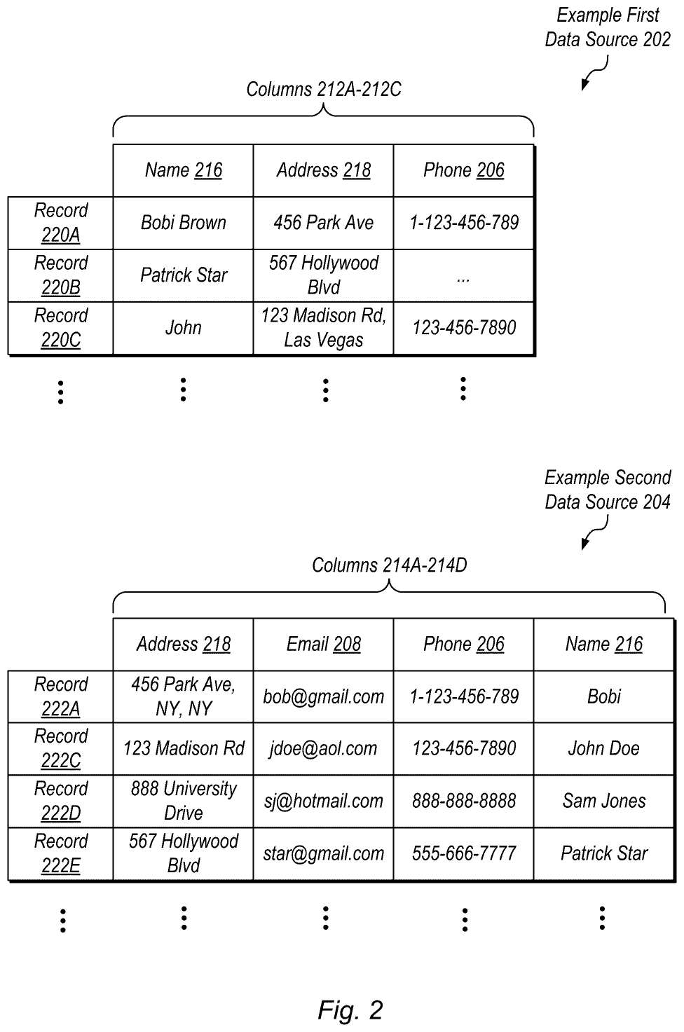

FIG. 2 is a diagram illustrating two different example data sources. In the illustrated embodiment, first data source 202 is shown stored in a table with columns 212A-212C and corresponding records 220A-220C. In the illustrated embodiment, record 220A is a row in a table of the first data source 202. Further in the illustrated embodiment, second data source 204 is shown stored in a table with columns 214A-214D and corresponding records 222A-222E. First data source 202 and second data source 204 are different data sources that include different data, but with some of the data overlapping. For example, first data source 202 is an internal data source stored and maintained by the computer system 110 shown in FIG. 1 and discussed in detail above, while second data source 204 is an external data source that is maintained by another system and has been acquired by computer system 110. In various situations, the external second data source 204 may be acquired from: a website, a company during a business acquisition, a company during a data acquisition, an end user (e.g., from an individual that is signing up for an account with computer system 110 when computer system already has some data from this user for a different account), etc.

In the illustrated embodiment, the records 220A-220C of first data source 202 store values for various columns 212A-212C. For example, record 220A stores the following values for the name 216 column 212A, address 218 column 212B, and phone 206 column 212C, respectively: “Bobi Brown,” “456 Park Ave,” and “1-123-456-789.” Similarly, records 220B stores values for the name 216 column and the address 218 column, but does not store a value for the phone 206 column. In various embodiments, example first data source 202 stores additional records having data for one or more additional entities (e.g., users).

In the illustrated embodiment, the records 222A-222E of second data source 204 store values for various columns 214A-214D. For example, record 222A stores the following values for address 218 column 212A, email 208 column 214B, phone 206 column 214C, and name 216 column 214D, respectively: “456 Park Ave, NY, NY,” “bob@gmail.com,” “1-123-456-789,” and “Bobi.” In various embodiments, example second data source 204 stores additional records storing data for one or more additional entities (e.g., users).

In the illustrated embodiment, record 220A included in first data source 202 and record 222A included in second data source 204 store values for the same user “Bobi Brown.” Similarly, record 220C included in first data source 202 and record 222C included in second data source 204 store values for the same user “John Doe.” As shown in FIG. 3, the disclosed computer system 110 (discussed above with reference to FIG. 1) identifies, using matching model 130, matching records in first data source 202 and second data source 204. Computer system 110 then combines the two data sources to generate an enhanced data source, such as example enhanced data source 342 shown in FIG. 3 and discussed in detail below. This enhanced data source is then usable to train machine learning model 150 to generate a prediction 152 for computer system 110.

FIG. 3 is a diagram illustrating an example enhanced data source. In the illustrated embodiment, an example combined data source 302 shows the combination of first data source 202 and second data source 204 prior to removing duplicate records. Example combined data source 302 includes records 220A-220C and 222A-222E from first data source 202 and second data source 204, respectively. Note that combined data source 302 includes records that have overlapping or duplicate data. For example, the portions of records in combined data source 302 that are shown in bold include overlapping or duplicate data. In the illustrated embodiment, two records for Bobi Brown are shown, one record including full name, partial address, and phone number and another record including a first name, full address, phone, and email. As shown in the illustrated embodiment, these two records are combined and the duplicate information (e.g., the phone number) is removed. This removal results in the record 324A that includes the following information within enhanced data source 342: “Bobi Brown,” “456 Park Ave, NY, NY,” “1-123-456-789,” and “bob@gmail.com.” This combined, enhanced record 324A is generated by removing duplicate values and adding a new column (email 208) to the Bobi Brown record that was not previously included in the Bobi Brown record of the first data source.

In the illustrated embodiment, enhanced data source 342 shows the result of removing duplicate records from combined data source 302. For example, enhanced data source 342 includes data from both first data source 202 and second data source 204, but does not include duplicate records from the two data sources. As shown in the illustrated embodiment, the data values shown in bold are those that were previously not included in both first data source 202 and second data source 204. For example, the phone number 206 for record 224B is not included in record 220B in first data source 202, but is included in second data source 204. Thus, when computer system 110 combines the two data sources, the phone number 206 for Patrick Star is added to the record for Patrick Star, resulting in the updated record 224B included in the enhanced data source 342.

### Example Embedded Space

FIG. 4 is a diagram illustrating an example embedded space. In the illustrated embodiment, embedded space 410 is a three-dimensional space that includes circles representing values of various columns of records from two different data sources. In the illustrated embodiment, key 430 shows that different patterned circles correspond to four different columns 412A, 414A, 412B, and 414B. Further, key 430 shows that columns 412A and 412B correspond to first data source 402 and columns 414A and 414B are from second data source 404.

In the illustrated embodiment, embedded space 410 shows three different clusters of values: a first cluster of values 432 from column 412B, a second cluster 442 of values from column 414B, and a third cluster of values from both column 414A and column 414B. The third cluster of values is labeled within the illustrated embodiment as a potential column pair 420. For example, because the values from two different columns from two different data sources (first data source 402 and second data source 404) have similar values within the three-dimensional embedded space, these columns are identified, by matching model 130, as a potential pair. This indicates, for example, that column 414A from the second data source and column 412A from the first data source likely store matching data. For example, these columns may store data for the same user.

Once computer system 110 identifies a potential column pair 420, the system uses these two columns as a matching feature (i.e., column pair 420 is one example of matching features 122). For example, a name record “Adidas” might be stored in column 414A while an email record sales@adidas.com might be stored in column 412A. Computer system 110 identifies these to values as a potential column pair 420. As discussed in further detail below, after identifying potential column pairs via embedding module 120, computer system 110 utilizes these pairs as matching features to train a machine learning model (e.g., matching model 130) to identify similar records 132. For example, a name record “Adidas” and an email record “sales@adidas.com” along with their similarity score (e.g., a similarity score calculated by embedding module 120 using a similarity algorithm) are used to train matching model 130 which columns store matching data.

To generate embedded space 410, computer system 110 executes embedding module 120 (shown in FIG. 1) to embed values included in first data source 402 and second data source 404. For example, embedding module 120 may execute one or more types of embedding models to generate the embedded values shown in embedded space 410. In some embodiments, embedding module 120 determines what type of data is stored in the columns 412A, 412B, 414A, and 414B. Based on the type of data stored in the columns, embedding module 120 selects and executes an embedding model on the data. For example, if the data include text (e.g., in English), then embedding module 120 selects a word2vec embedding algorithm and executes this algorithm on the text data stored in columns 412A, 412B, 414A, and 414B to generate the values, such as values 432, shown in embedded space 410. As another example, if the data in columns 412A, 412B, 414A, and 414B stores graph data (nodes representing entities and edges representing electronic communications, such as transactions, between those entities), then embedding module 120 selects a node2vec algorithm or a GraphSAGE algorithm to capture the structural and semantic properties of the different nodes in the graph data. In some embodiments, embedding module 120 selects multiple different types of embedding algorithms to perform on the data stored in columns 412A, 412B, 414A, and 414B based on these columns storing more than one type of data. For example, the columns shown in FIG. 4 may store one or more of, graph data, symbolic data, text data in different languages (e.g., English, Chinese characters, Spanish, etc.), numeric data, etc.

To determine that the clusters of values for column 412A and column 414A are a potential pair, embedding module 120 executes a similarity measurement algorithm. For example, embedding module 120 calculates similarity scores using a distance measuring algorithm. In some embodiments, embedding module 120 calculates similarity scores for pairs of embedded values within embedded space 410. For example, embedding module 120 calculates a similarity score between a value of column 412A and a value of column 414A. In other embodiments, embedding module 120 calculates similarity scores for pairs of column clusters. For example, embedding module 120 calculates a similarity score between all values of column 412A (i.e., the cluster of values for column 412A in embedded space 410) and all values of column 414A (i.e., the cluster of values for column 414A in embedded space 410). In various embodiments, embedding module 120 calculates a similarity value for respective pairs of the clusters shown in FIG. 4. For example, embedding module 120 calculates a similarity value for the clusters for columns 414A and 412B, a similarity value for columns 414A and 414B, a similarity value for columns 412B and 414B, etc.

In various embodiments, embedding module 120 executes one or more of the following types of distance measuring algorithms to measure similarities between column clusters 442 in embedded space 410: Jaccard distance algorithm, Levenshtein distance algorithm, ARI (adjusted rand index) algorithm. As one example, embedding module 120 executes Levenshtein distance algorithm to measure the similarity between pairs of embedded values. In contrast, embedding module 120 executes the adjusted rand index (ARI) algorithm to measure the similarity between two data cluster by considering all the pairs of samples in the two clusters and then counting pairs of samples that are assigned in the same (or different) clusters. For example, embedding module 120 calculates an ARI similarity value for the clusters for columns 412A and 414A to determine if these two clusters are a potential column pair 420. Embedding module 120 calculates the ARI similarity value for columns 412A and 414A by considering all pairs of samples (i.e., values within a column) and counting the pairs of samples that have similar ARI values and that are assigned to different clusters in order to determine a total number of similar sample pairs for the two columns 412A and 414A. Embedding module 120 calculates the ARI value using the following formula:

$$ARI = \frac{( rand index - expected rand index )}{( max ( rand index ) - expected rand index )}$$

The rand index is determined to be 0 when two sets of points from two different clusters are assigned randomly to that cluster and is determined to be equal to 1 when the two cluster results (e.g., multiple points within the two clusters) are the same. The expected rand index is the expected value of the rand index when two lusters are independent or random. This value accounts for the fact that some agreement or similarity between clusters may happen by chance. In this way, the expected rand index is subtracted within the Air formula to correct for this chance agreement, making the ARI a more robust measure than an unadjusted rand index. Dividing by a maximum (max) rand index value normalizes the index value such that its value ranges from −1 to 1 and allows for the ARI to be interpreted consistently, regardless of the number of clusters or the size of the dataset being analyzed. The max rand index value is the rand index value when two clusters are identical (every pair of points is either in the same cluster in both clusters or in different clusters in both clusters). The max rand index value depends on the number of clusters and the distribution of elements across these clusters and represents the maximum achievable agreement between two clusters. For example, in a perfect scenario where two clusters are identical, the rand index is equal to the max rand index.

### Example Feedback Loop

FIG. 5 is a block diagram illustrating an example feedback loop. In the illustrated embodiment, computer system 110 includes loss module 510, in addition to matching model 130, enhancing module 140, and machine learning model 150, which are discussed in detail above with reference to FIG. 1. In the illustrated embodiment, these elements from FIG. 1 are part of a model pipeline 530 being iteratively trained by loss module 510 via reinforcement learning feedback loop 512. Said another way, FIG. 5 illustrates training of the pipeline of machine learning models that are described in detail above with reference to FIG. 1.

Loss module 510, in the illustrated embodiment, includes termination module 520. Loss module 510, in the illustrated embodiment, receives prediction 152 from machine learning model 150 based on enhanced data source 142. Loss module 510 executes termination module 520 to determine, based on prediction 152, whether to terminate training of model pipeline 530 that includes matching model 130 and machine learning model 150. In some embodiments, loss module 510 executes an optimizer to minimize the loss function calculated by termination module 520 for predictions 152 generated by machine learning model. For example, loss module 510 may execute an adaptive moment estimation (Adam) optimizer.

In some embodiments, termination module 520 compares the prediction 152 generated by machine learning model 150 with a known prediction. If prediction 152 differs from the known prediction by more than a threshold amount, then loss module 510 sends feedback via reinforcement learning feedback loop 512 to matching model 130. If, however, prediction 152 is less than a threshold amount different from the known prediction, then termination module 520 terminates training of model pipeline 530. In other embodiments, termination module 520 calculates a binary cross-entropy loss for machine learning model 150 based on prediction 152. For example, if a binary cross-entropy loss value calculated for machine learning model 150 based on prediction 152 is below a loss value threshold set by loss module 510, then termination module 520 terminates training of model pipeline 530. If, however, the binary cross-entropy loss value is above the loss value threshold, termination module 520 outputs an indication that additional training is necessary. Based on this indication, loss module 510 provides feedback (e.g., adjusted weights for matching model 130) via reinforcement learning feedback loop 512 to matching model 130.

In some embodiments, termination module 520 converts or normalizes the loss value to a binary value. Termination module 520 takes this binary value and feeds it back to matching model 130 via reinforcement learning feedback loop 512. For example, termination module 520 converts the prediction (e.g., classification) output by machine learning model 150 to a binary result that will fit the binary cross-entropy loss calculated for matching model 130. As one specific example, if machine learning model 150 outputs a prediction 152 indicating a total payment volume of $400 for a merchant, but the actual total payment volume for this merchant is $300, then termination module 520 calculates a normalized loss value for this prediction as 0.75. In this example, termination module 520 sends the loss value of 0.75 to matching model 130 via reinforcement learning feedback loop 512. This loss value causes matching model 130 to make small adjustments to its weights since it is still not accurate (the model does not yet meet training standards set by loss module 510) according to the loss value generated by termination module 520. In some embodiments, termination module 520 applies a normalization factor to the loss value based on the maximum loss calculated for matching model 130 during training. For example, the loss value for the example above might become 0 if this prediction 152 was the model's biggest mistake thus far during training.

Computer system 110 repeats the model pipeline feedback training loop 512 shown in FIG. 5 for model pipeline 530 until the output of machine learning model 150 satisfies the loss threshold set by loss module 510. In some embodiments, termination module 520 terminates training based on prediction 152 being the same as a prediction output by machine learning model 150 during a prior iteration of model pipeline 530. For example, if the output of machine learning model 150 does not change after one or more iterations of training, then loss module 510 terminates training of model pipeline 530. Said another way, if machine learning model 150 is not improving after several iterations of training, then the model is considered “trained” by loss module 510.

### Example Action System

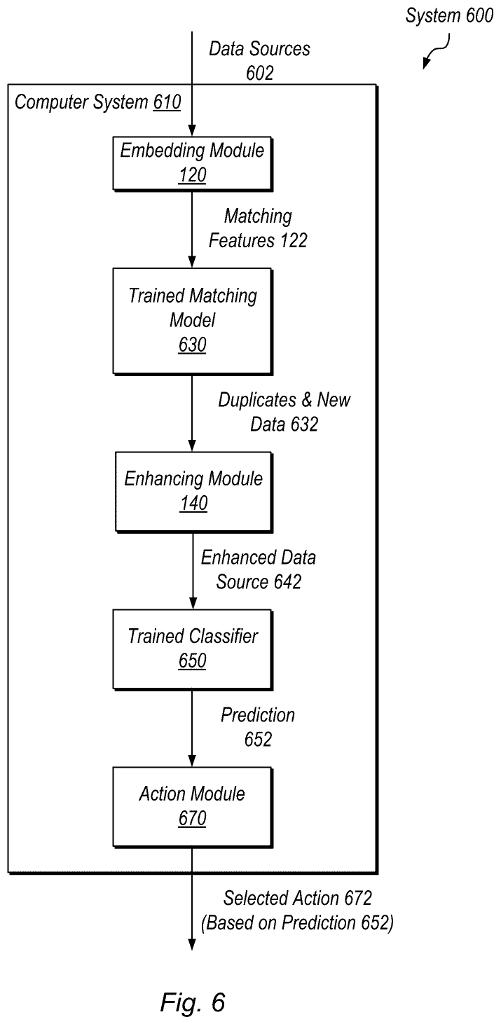

FIG. 6 is a block diagram illustrating an example system configured to perform one or more actions based on a prediction of a classifier trained on enhanced data. In the illustrated embodiment, system 600 includes computer system 610, which in turn includes embedding module 120, trained matching model 630, enhancing module 140, trained classifier 650, and action module 670. In some embodiments, system 610 is one example of computer system 110. For example, computer system 110 both trains and executes model 630 and classifier 650. In other embodiments, system 610 is a different system than computer system 110. For example, computer system 610 receives and executes trained versions of model 630 and classifier 650 received from computer system 110.

Computer system 610, in the illustrated embodiment, receives two or more data sources 602 and generates matching features 122 using embedding module 120. Computer system 610 then feeds matching features 122 into trained matching model 630. In the illustrated embodiment, trained matching model 630 outputs information indicating duplicates identified within the two or more data sources 602 as well as new data 632 included in the two or more data sources. As one example in the context of FIG. 3, trained matching model 630 identifies that record 220B and record 222E store a duplicate first name, last name, and address for the user “Patrick.”

In the illustrated embodiment, enhancing module 140 receives the identified duplicates and new data 632 and generates an enhanced data source 642 by combining the two or more data sources 602 and removing duplicate data. Computer system 610, in the illustrated embodiment, executes trained classifier 650 to generate a prediction 652 based on the enhanced data source 642. For example, trained classifier 650 predicts, based on enhanced data source 642, a total payment volume for a given merchant. In this example, if trained classifier 650 were to make this prediction based on one of original data sources 602, then the total payment volume would not be as accurate as the total payment volume generated based on the enhanced data source 642.

Action module 670, in the illustrated embodiment, receives prediction 652 from trained classifier 650. Based on this prediction 652, action module 670 selects and outputs an action 672 to be performed by computer system 610 (or by another computer system). For example, if prediction 652 indicates that a merchant's total payment volume is going to be below an expected volume for a given year, then action module 670 selects a notification action to cause computer system 610 to send a notification to that merchant regarding the low payment volume. As another example, if prediction 652 indicates that data transmissions from a first server to a second server within a network of servers are faulty (e.g., too many dropped packets, slow transmissions, etc.), then action module 670 selects an action that will cause the first server to repair itself or to shut down. In this example, action module 670 then causes another server to take its place in the server network. As another example, prediction 652 may indicate, based on the enhanced data source 642, that one or more trading actions should not be performed. In this example, if the enhanced data source 642 includes historical investment data, then trained classifier 650 generates a prediction based on these prior investments and action module 670 selects one or more future investment actions to be performed. As another example, if prediction 652 indicates that a user is trustworthy, then action module 670 selects a high line of credit to be approved for this user. As another example, if prediction 652 indicates a new user is similar to a prior user based on data matching, then action module 670 selects a similar or the same product that was offered to the prior user to offer to the new user. In some situations, action module 670 selects one or more preventative actions to be performed by computer system 610, including additional authentication actions (such as multi-factor authentication), restricting user access (e.g., to data within system 600), blocking future user actions, locking a user's account (e.g., based on prediction 652 indicating that this user is suspicious), etc.

### Example Company Data Acquisition

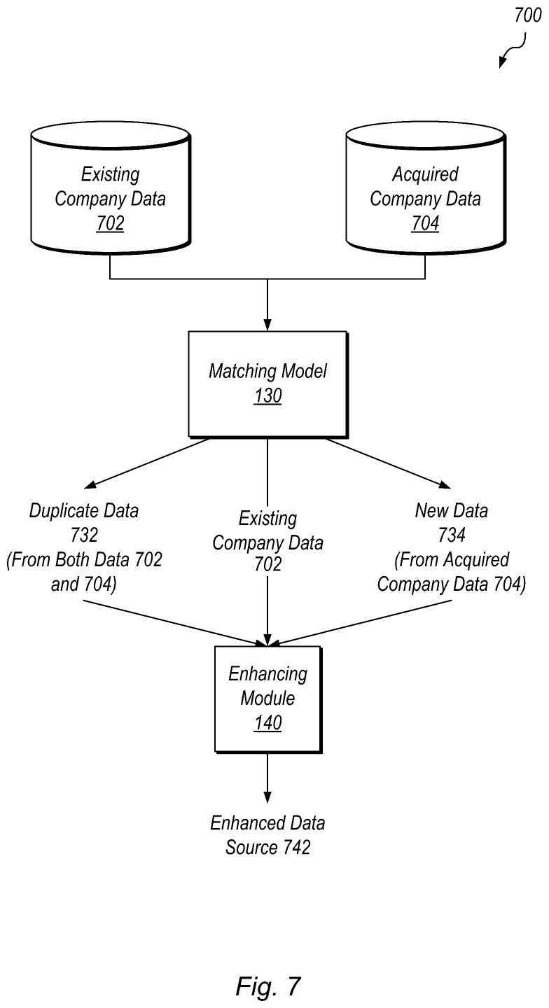

FIG. 7 is a block diagram illustrating an example system configured to combine data of an existing company and an acquired company. In the illustrated embodiment, system 700 includes existing company data 702, acquired company data 704, matching model 130, and enhancing module 140. In the illustrated embodiment, system 700 combines data from two different companies after an existing company has acquired another company. The disclosed matching model 130 quickly identifies matching data such that the system 700 is able to cut the time down for combining the companies' data from months or even years to hours or days.

Matching model 130, in the illustrated embodiment, receives existing company data 702 and acquired company data 704 and outputs information indicating duplicate data 732 (i.e., duplicate records found in both existing company data 702 and acquired company data 704), existing company data 702, and new data 734 (i.e., new records that were not previously included in existing company data 702). These three pieces of information are fed into enhancing module 140, which combines the data and removes duplicates to generate enhanced data source 742. For example, if duplicate data 732 indicates that both data 702 and data 704 include a record for a company, such as Nike.com, then after adding the acquired company data 704 to the existing company data 702, enhancing module 140 removes one of these duplicate records. In this example, enhancing module 140 produces enhanced data source 742 free of data redundancy by removing the duplicate record (one portion of duplicate data 732) identified by matching model 130. When identifying duplicate data, matching model 130 determines that two columns store the same value for two different records. Based on this determination, matching model indicates that the two columns of these two different records store duplicate data 732. In the illustrated embodiment, enhancing module 140 combines the two different records, but removes one of the values for the duplicate column identified by matching model 130 (such that only one column within the “combined” record stores the duplicate value). In addition to identifying duplicate data, through matching information provided by matching model 130, enhancing module 140 is able to enrich one or more data sources. For example, when identifying duplicate records, a duplicate record might have additional attributes that another, existing (matching) record lacks (e.g., a phone number or email address). Enhancing module 140 adds this additional information to the existing record and then deletes the duplicate record.

### Example Methods

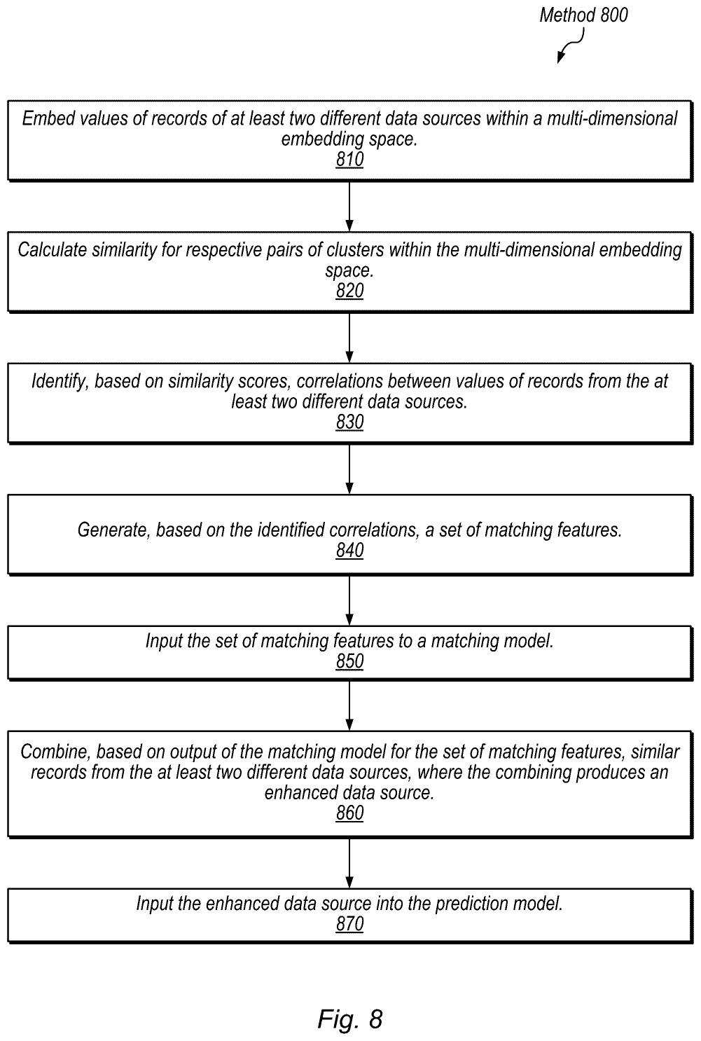

FIG. 8 is a flow diagram illustrating an example method for using a pipeline of machine learning models to generate and utilize an enhanced data source, according to some embodiments. The method 800 shown in FIG. 8 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, computer system 110 performs the elements of method 800.

At 810, in the illustrated embodiment, a computer system embeds values of records of at least two different data sources within a multi-dimensional embedding space. In some embodiments, the embedding includes determining a type of content included in the at least two different data sources. In some embodiments, the embedding includes selecting, based on determining the type of content, at least one of a plurality of different embedding algorithms for embedding the values of the records. In some embodiments, the selecting includes selecting, based on determining that a first data source includes categorical data, a word-to-vector (Word2Vec) embedding algorithm for embedding values of records in the first data source. In some embodiments, the selecting includes selecting, based on determining that a second, different data source includes numerical data, a convolutional neural network (CNN) embedding algorithm for embedding values of records in the second, different data source.

In some embodiments, the embedding includes determining a type of content included in the first data source and the second, different data source. In some embodiments, the embedding includes selecting, based on determining that the first data source includes graph data, a node-to-vector (Node2Vec) embedding algorithm for capturing structural and semantic properties of different nodes in the first data source.

At 820, the computer system calculates, for respective pairs of clusters within the multi-dimensional embedding space, similarity scores. In some embodiments, calculating the similarity scores includes executing a similarity measurement algorithm to measure differences between clusters in the multi-dimensional embedding space that correspond to values of different columns of data in the two different data sources. In some embodiments, executing the similarity measurement algorithm includes determining a similarity between two clusters in the multi-dimensional embedding space by measuring a distance between different pairs of samples in two or more different clusters. In some embodiments, executing the similarity measurement algorithm includes adding pairs that have short distances between them but belong to different clusters, where identifying the correlations includes identifying, based on the adding, which cluster pairs have the greatest number of pairs relative to other cluster pairs. In some embodiments, executing a similarity measurement algorithm to measure differences between clusters in the multi-dimensional embedding space that correspond to values of different columns of data in the first data source and the second, different data source, where the similarity measurement algorithm calculates an adjusted rand index of a plurality of pairs of two different clusters in the multi-dimensional embedding space.

At 830, the computer system identifies, based on the similarity scores, correlations between values of records from the at least two different data sources. In some embodiments, based on two different groups of embedded values from two different columns in the two different data sources having similarity scores that are close together or overlap in the multi-dimensional embedding space, the computer system identifies that the two columns are a potential pair. For example, these two columns coming from two different data sources have matching records. In some embodiments, the multi-dimensional space is a three-dimensional space as discussed above with reference to FIG. 4.

At 840, the computer system generates, based on the identified correlations, a set of matching features. In some embodiments, the matching features are used to train the matching model to identify similar records from two or more different data sources.

At 850, the computer system inputs the set of matching features to a matching model. In some embodiments, the computer system trains the matching model using the set of matching features. For example, computer system inputs labels corresponding to features in the set of matching features into the matching model along with the set of matching features. These labels indicate that records from two different data sources match. In this way, the matching model learns to identify matching records originating from different data sources (e.g., from internal and external data sources).

At 860, the computer system combines, based on output of the matching model for the set of matching features, similar records from the at least two different data sources, where the combining produces an enhanced data source. In some embodiments, the combining includes adding new columns to the first data source, where the new columns are columns that were previously included in the second, different data source. In some embodiments, the combining is performed based on output of the matching model indicating that values of the new columns match values of other columns that are included in the first data source. In some embodiments, the combining includes deleting, based on output of the matching model indicating that the first data source and the second, different data source include duplicate columns, one or more duplicate columns from the enhanced data source.

At 870, the computer system inputs the enhanced data source into the prediction model. In some embodiments, the prediction model is a machine learning classifier. For example, prediction model is a k-nearest neighbors (KNN) classifier. As another example, prediction model is a neural network classifier. In some embodiments, inputting the enhanced data source into the prediction model includes generating, by the prediction model based on the enhanced data source, one or more predictions. In some embodiments, the computer system performs, based on the one or more predictions, one or more actions relative to one or more entities corresponding to the one or more predictions. For example, if the prediction model outputs a prediction indicating the total payment volume (TPV) of a merchant for a future year based on previous payment volumes of this merchant, then computer system transmits a notification to this merchant indicating the predicted total payment volume. Further in this example, the computer system executes the machine learning classifier to predict the merchant's loss for the next year based on the predicted total payment volume. As another example, the prediction model outputs a classification indicating whether an entity corresponds to a physical location. In this example, prediction model may predict whether a merchant owns a physical store or is performing transactions electronically (e.g., online transactions). As another example, the prediction model outputs a classification indicating whether an entity is risky based on the entity's historical behavior (e.g., prior electronic transaction, browsing behavior, etc.).

In some embodiments, the method for training the prediction model further comprises executing, by the computer system, a feedback loop including backpropagating a first output of the prediction model into the matching model to update the matching model. In some embodiments, the method for training the prediction model further comprises performing, by the computer system after adjusting the matching model, a second execution of the pipeline of machine learning models, where the second execution includes performing the inputting the set of matching features, the combining, and the inputting the enhanced data source to update the matching model. In some embodiments, the feedback loop trains the matching model to not only generate accurate matches between records of two different data sources, but also to generate matches that are personalized for the prediction model. In some embodiments, executing the feedback loop further includes converting, based on a prediction threshold, the first output of the prediction model to a binary value. In some embodiments, executing the feedback loop further includes generating, using a loss function, a loss value for the prediction model based on the binary value. In some embodiments, executing the feedback loop further includes performing, based on the loss value, backpropagation on the matching model to update weights of the matching model.

In some embodiments, the computer system evaluates, after executing the feedback loop and the second execution of the pipeline of machine learning models, performance of the prediction model has improved, where the evaluating includes comparing the first output of the prediction model with updated output of the prediction model after the second execution of the pipeline of machine learning models. In some embodiments, in response to determining, based on the evaluating, that the updated output of the prediction model is within a threshold similarity to the first output of the prediction model, the computer system terminating execution of the pipeline of machine learning models.

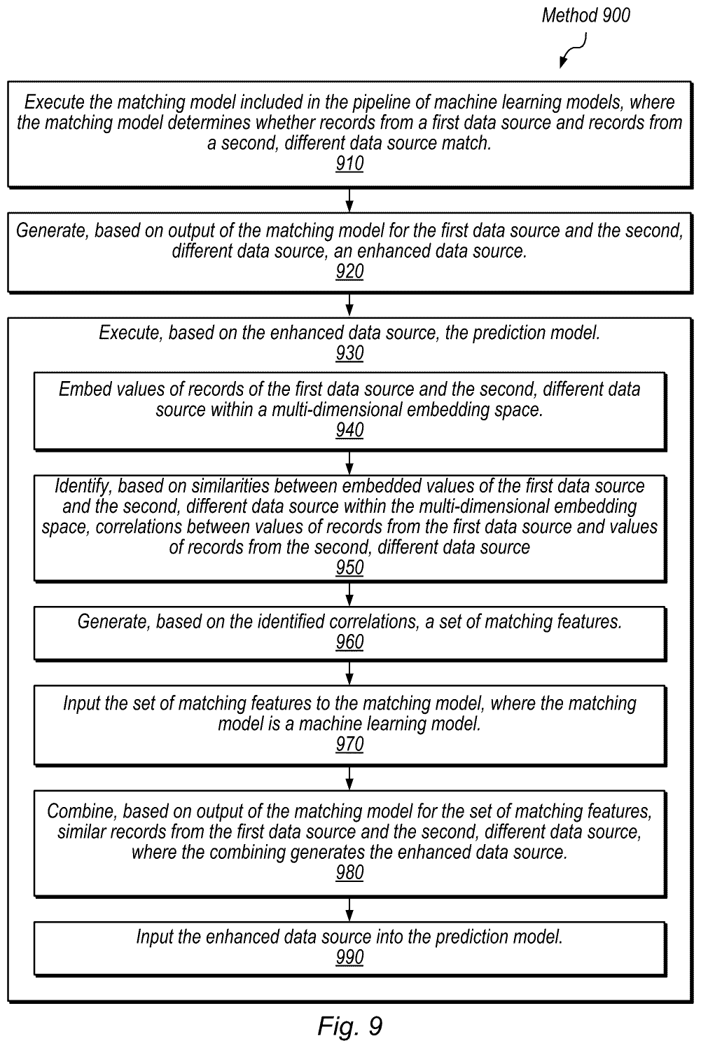

FIG. 9 is a flow diagram illustrating an example method for automatically generating a prediction using a pipeline of machine learning models that includes a matching model and a prediction model, according to some embodiments. The method 900 shown in FIG. 9 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, computer system 110 performs the elements of method 900.

At 910, in the illustrated embodiment, a computer system executes the matching model included in the pipeline of machine learning models, where the matching model determines whether records from a first data source and records from a second, different data source match. For example, if the matching model determines that a record from the first data source and a record from the second, different data source store values for the same entity (e.g., the same user), then the computer system combines the two records.

At 920, the computer system generates, based on output of the matching model for the first data source and the second, different data source, an enhanced data source. In some embodiments, generating the enhanced data source includes combining the first data source and the second data source. For example, the combining may include removing duplicate records or combining one record from the first data source and another record from the second data source based on these two records storing information for the same user.

At 930, the computer system executes the prediction model based on the enhanced data source. In some embodiments, the prediction model is a machine learning classifier. In some embodiments, the prediction model outputs a classification for the enhanced data source. For example, the prediction model classifies data included in the enhanced data source suspicious (e.g., potentially fraudulent or malicious). In this example, the computer system may perform one or more actions based on the classification output by the prediction model. As one specific example, the computer system may perform a preventative action such as requiring additional authentication from a user associated with a portion of the enhanced data when the classification output by the prediction model indicates that this user is potentially fraudulent.

At 940, the computer system generates the pipeline of machine learning models by embedding values of records of the first data source and the second, different data source within a multi-dimensional embedding space. In some embodiments, the embedding includes determining a type of content included in the first data source and the second, different data source. In some embodiments, the embedding includes selecting, based on determining the type of content, at least one of a plurality of different embedding algorithms for embedding the values of the records. In some embodiments, the embedding includes determining a type of content included in the first data source and the second, different data source. In some embodiments, the embedding includes selecting, based on determining that the first data source includes graph data, a node-to-vector (Node2Vec) embedding algorithm for capturing structural and semantic properties of different nodes in the first data source.

At 950, the computer system generates the pipeline of machine learning models by identifying, based on similarities between embedded values of the first data source and the second, different data source within the multi-dimensional embedding space, correlations between values of records from the first data source and values of records from the second, different data source. In some embodiments, the identifying includes executing a similarity measurement algorithm to measure differences between clusters in the multi-dimensional embedding space that correspond to values of different columns of data in the first data source and the second, different data source, where executing the similarity measurement algorithm includes determining a similarity between two clusters in the multi-dimensional embedding space by measuring a distance between different pairs of samples in two or more different clusters.

At 960, the computer system generates the pipeline of machine learning models by generating a set of matching features based on the identified correlations. In some embodiments, the identified correlations include values of columns of the first and second data sources that have similar values within the multi-dimensional embedding space.

At 970, the computer system generates the pipeline of machine learning models by inputting the set of matching features to the matching model, where the matching model is a machine learning model. In some embodiments, the matching model is a supervised machine learning model. In other embodiments, the matching model is an unsupervised machine learning model. In some embodiments, the matching model is a neural network.

At 980, the computer system generates the pipeline of machine learning models by combining, based on output of the matching model for the set of matching features, similar records from the first data source and the second, different data source, where the combining generates the enhanced data source. In some embodiments, the enhanced data source includes a combination of an internal data source (e.g., data that is stored internally to and is managed by the computer system) and an external data source (e.g., data that is stored and maintained by another system, but has been acquired by the computer system).

At 990, the computer system generates the pipeline of machine learning models by inputting the enhanced data source into the prediction model. In some embodiments, the pipeline of machine learning models is further generated by executing a feedback loop including backpropagating a first output of the prediction model into the matching model to update the matching model. In some embodiments, the pipeline of machine learning models is further generated by performing, after adjusting the matching model, a second execution of the pipeline of machine learning models, where the second execution includes performing the inputting the set of matching features, the combining, and the inputting the enhanced data source to update the matching model.

In addition to methods 800 and 900 and their variants, non-transitory, computer-readable media storing program instructions executable to implement such methods are also contemplated, along with systems configured to implement these methods.

The various techniques described herein may be performed by one or more computer programs. The term “program” is to be construed broadly to cover a sequence of instructions in a programming language that a computing device can execute. Computer system 110, shown in FIG. 1, may also be referred to herein as a “computer system” and is one example of the computing device that may execute various sequences of instructions that make up a program. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” in order to facilitate execution of the program instructions by a computer system, such as computer system 110 or system 700. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system such as computer system 110) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

The present disclosure refers to various software operations that are performed in the context of one or more computer systems. Embedding module 120, enhancing module 140, modules executing either of matching model 130 or machine learning model 150 can each execute on respective computer systems, for example. Each of these components, then, is implemented on physical structure (i.e., on computer hardware).

In general, any of the services or functionalities of a software development environment described in this disclosure can be performed by a host computing device, which is any computer system, such as computer system 110, that is capable of connecting to a computer network. A given host computing device can be configured according to any known configuration of computer hardware. A typical hardware configuration includes a processor subsystem, memory, and one or more I/O devices coupled via an interconnect. For example, computer system 110 receives first data source 102 and second data source 104 from system 100 or from another computer system or computing device via an interconnect corresponding to an I/O device of computer system 110 and stores data in a memory, such as a database utilized by computer system 110 to store first data source 102, second data source 104, or enhanced data source 142, as shown in FIG. 1. For example, the tables shown in FIGS. 2 and 3 storing data for example first data source 202, example second data source 204, and example enhanced data source 342 are stored by computer system 110 in a database maintained by system 100. A given computer system such as system 110 or a computing device communicating with computer system 110 may also be implemented as two or more computer systems operating together.

The processor subsystem of the host computing device may include one or more processors or processing units. In some embodiments of the host computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the host computing device is usable to store program instructions executable by the processor subsystem to cause the host computing device to perform various operations described herein. The system memory may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read-only memory (PROM, EEPROM, etc.), and so on. Memory in the host computing device is not limited to primary storage. Rather, the host computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the host computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method for training a prediction model using a pipeline of machine learning models, the method comprising:
embedding, by a computer system, values of records of at least two different data sources within a multi-dimensional embedding space;
calculating, by the computer system for respective pairs of clusters within the multi-dimensional embedding space, similarity scores;
identifying, by the computer system based on the similarity scores, correlations between values of records from the at least two different data sources;
generating, by the computer system based on the identified correlations, a set of matching features;
inputting, by the computer system, the set of matching features to a matching model;
combining, by the computer system based on output of the matching model for the set of matching features, similar records from the at least two different data sources, wherein the combining produces an enhanced data source; and
inputting, by the computer system, the enhanced data source into the prediction model.

2. The method of claim 1, wherein the method for training the prediction model further comprises:
executing, by the computer system, a feedback loop including backpropagating a first output of the prediction model into the matching model to update the matching model; and
performing, by the computer system after adjusting the matching model, a second execution of the pipeline of machine learning models, wherein the second execution includes performing the inputting the set of matching features, the combining, and the inputting the enhanced data source to update the matching model.

3. The method of claim 2, wherein executing the feedback loop further includes:
converting, based on a prediction threshold, the first output of the prediction model to a binary value;
generating, using a loss function, a loss value for the prediction model based on the binary value; and
performing, based on the loss value, backpropagation on the matching model to update weights of the matching model.

4. The method of claim 2, further comprising:
evaluating, by the computer system after executing the feedback loop and the second execution of the pipeline of machine learning models, performance of the prediction model has improved, wherein the evaluating includes comparing the first output of the prediction model with updated output of the prediction model after the second execution of the pipeline of machine learning models; and
in response to determining, based on the evaluating, that the updated output of the prediction model is within a threshold similarity to the first output of the prediction model, the computer system terminating execution of the pipeline of machine learning models.

5. The method of claim 1, wherein the embedding includes:
determining a type of content included in the at least two different data sources; and
selecting, based on determining the type of content, at least one of a plurality of different embedding algorithms for embedding the values of the records.

6. The method of claim 5, wherein the selecting includes:
selecting, based on determining that a first data source includes categorical data, a word-to-vector (Word2Vec) embedding algorithm for embedding values of records in the first data source; and
selecting, based on determining that a second, different data source includes numerical data, a convolutional neural network (CNN) embedding algorithm for embedding values of records in the second, different data source.

7. The method of claim 1, wherein calculating the similarity scores includes:
executing a similarity measurement algorithm to measure differences between clusters in the multi-dimensional embedding space that correspond to values of different columns of data in the two different data sources.

8. The method of claim 7, wherein executing the similarity measurement algorithm includes:
determining a similarity between two clusters in the multi-dimensional embedding space by measuring a distance between different pairs of samples in two or more different clusters; and
adding pairs that have short distances between them but belong to different clusters, wherein identifying the correlations includes identifying, based on the adding, which cluster pairs have the greatest number of pairs relative to other cluster pairs.

9. A non-transitory computer-readable medium having instructions stored thereon that are executable by a computing device to perform operations comprising:
embedding values of records of a first data source and a second, different data source within a multi-dimensional embedding space;
calculating, for respective pairs of clusters within the multi-dimensional embedding space, similarity scores;
identifying, based on the similarity scores, correlations between values of records from the first data source and values of records from the second, different data source;
generating, based on the identified correlations, a set of matching features;
inputting the set of matching features to a matching model, wherein the matching model is a machine learning model;
combining, based on output of the matching model for the set of matching features, matching records from the first data source and the second, different data source, wherein the combining produces an enhanced data source; and
inputting the enhanced data source into a prediction model, wherein the prediction model is a machine learning classifier, wherein the matching model and the prediction model are included in a pipeline of machine learning models.

10. The non-transitory computer-readable medium of claim 9, wherein the operations further comprise:
executing a feedback loop including backpropagating a first output of the prediction model into the matching model to update the matching model; and
performing, after adjusting the matching model, a second execution of the pipeline of machine learning models, wherein the second execution includes performing the inputting the set of matching features, the combining, and the inputting the enhanced data source to update the matching model.

11. The non-transitory computer-readable medium of claim 9, wherein inputting the enhanced data source into the prediction model includes generating, by the prediction model based on the enhanced data source, one or more predictions, and wherein the operations further comprise:
performing, based on the one or more predictions, one or more actions relative to one or more entities corresponding to the one or more predictions.

12. The non-transitory computer-readable medium of claim 10, further comprising:
evaluating, after executing the feedback loop and the second execution of the pipeline of machine learning models, performance of the prediction model has improved, wherein the evaluating includes comparing the first output of the prediction model with updated output of the prediction model after the second execution of the pipeline of machine learning models; and
in response to determining, based on the evaluating, that the updated output of the prediction model is within a threshold similarity to the first output of the prediction model, the computer system terminating execution of the pipeline of machine learning models.

13. The non-transitory computer-readable medium of claim 9, wherein the combining includes:
adding new columns to the first data source, wherein the new columns are columns that were previously included in the second, different data source, wherein the combining is performed based on output of the matching model indicating that values of the new columns match values of other columns that are included in the first data source; and
deleting, based on output of the matching model indicating that the first data source and the second, different data source include duplicate columns, one or more duplicate columns from the enhanced data source.

14. The non-transitory computer-readable medium of claim 9, wherein the embedding includes:
determining a type of content included in the first data source and the second, different data source; and
selecting, based on determining that the first data source includes graph data, a node-to-vector (Node2Vec) embedding algorithm for capturing structural and semantic properties of different nodes in the first data source.

15. The non-transitory computer-readable medium of claim 9, wherein calculating the similarity scores includes:
executing a similarity measurement algorithm to measure differences between clusters in the multi-dimensional embedding space that correspond to values of different columns of data in the first data source and the second, different data source, wherein the similarity measurement algorithm calculates an adjusted rand index of a plurality of pairs of two different clusters in the multi-dimensional embedding space.

16. A method for automatically generating a prediction using a pipeline of machine learning models that includes a matching model and a prediction model, the method comprising:
executing, by a computer system, the matching model included in the pipeline of machine learning models, wherein the matching model determines whether records from a first data source and records from a second, different data source match;
generating, by the computer system based on output of the matching model for the first data source and the second, different data source, an enhanced data source;
executing, by the computer system based on the enhanced data source, the prediction model, wherein the pipeline of machine learning models is generated by:
embedding values of records of the first data source and the second, different data source within a multi-dimensional embedding space;
identifying, based on similarities between embedded values of the first data source and the second, different data source within the multi-dimensional embedding space, correlations between values of records from the first data source and values of records from the second, different data source;
generating, based on the identified correlations, a set of matching features;
inputting the set of matching features to the matching model, wherein the matching model is a machine learning model;
combining, based on output of the matching model for the set of matching features, similar records from the first data source and the second, different data source, wherein the combining generates the enhanced data source; and
inputting the enhanced data source into the prediction model.

17. The method of claim 16, wherein the pipeline of machine learning models is further generated by:
executing a feedback loop including backpropagating a first output of the prediction model into the matching model to update the matching model.

18. The method of claim 17, wherein the pipeline of machine learning models is further generated by:
performing, after adjusting the matching model, a second execution of the pipeline of machine learning models, wherein the second execution includes performing the inputting the set of matching features, the combining, and the inputting the enhanced data source to update the matching model.

19. The method of claim 16, wherein the embedding includes:
determining a type of content included in the first data source and the second, different data source; and
selecting, based on determining the type of content, at least one of a plurality of different embedding algorithms for embedding the values of the records.

20. The method of claim 16, wherein identifying includes:
executing a similarity measurement algorithm to measure differences between clusters in the multi-dimensional embedding space that correspond to values of different columns of data in the first data source and the second, different data source, wherein executing the similarity measurement algorithm includes determining a similarity between two clusters in the multi-dimensional embedding space by measuring a distance between different pairs of samples in two or more different clusters.
